(19) United States
(12) Patent Application Publication
(10) Pub. No.: US 2023/0380502 A1
(43) Pub. Date: Nov. 30, 2023

(54) AEROSOL PROVISION DEVICE

(71) Applicant: Nicoventures Trading Limited, LONDON (GB)

(72) Inventors: Daniel LOCHTMAN, Winston Salem, NC (US); David BUREAU, London (GB); James SHERIDAN, London (GB)

(21) Appl. No.: 18/248,300

(22) PCT Filed: Oct. 15, 2021
(86) PCT No.: PCT/EP2021/078679

§ 371 Date: Apr. 7, 2023

(30) Foreign Application Priority Data
Oct. 16, 2020 (GB) 2016475.2

(51) Int. Cl. A24F 40/465; A24F 40/70

(52) U.S. Cl. CPC A24F 40/465; A24F 40/70; A24F 40/20

(57) ABSTRACT

An aerosol provision device has a heater assembly with a receptacle defining a heating chamber arranged to receive at least a portion of an article including aerosol generating material, a heating element configured to heat a portion of the article received in the heating chamber, and a mount supporting the heating element. The heating element includes a heating portion and an anchoring portion, and the anchoring portion is insert molded into the mount such that the anchoring portion is embedded within the mount. Also disclosed are a heater assembly of the device, methods of forming the same, and an aerosol provision system that includes the device and an article comprising aerosol generating material.

### TECHNICAL FIELD

The present invention relates to an aerosol provision device. The present invention also relates to an aerosol provision device heater assembly, methods of forming the same, and an aerosol provision system comprising the aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device. The device comprises a heater assembly having a receptacle defining a heating chamber arranged to receive at least a portion of an article comprising aerosol generating material, a heating element configured to heat a portion of the article received in the heating chamber, and a mount supporting the heating element. The heating element includes a heating portion and an anchoring portion, and the anchoring portion is insert moulded into the mount such that the anchoring portion is embedded within the mount.

The heating element may be made as a one piece component. In other words, the heating portion and anchoring portion may be integrally formed together.

The anchoring portion may also be said to be enveloped by the mount.

In a further embodiment of the above aspect, the heating portion extends from the anchoring portion and extends from the mount.

The heating portion may extend along the longitudinal axis of the heater assembly.

In a further embodiment of any of the above, the anchoring portion comprises an anchoring feature.

The anchoring feature is a feature that increases the area of contact between the mount and the anchoring portion to help improve the strength of the bond there between.

In a further embodiment of the above, the anchoring feature comprises a recess in the anchoring portion and a portion of the mount is received by the recess to couple the anchoring portion to the mount.

In a further embodiment of the above, the recess comprises a through-hole in the anchoring portion, and a portion of the mount extends through the through-hole to couple the anchoring portion to the mount.

In a further embodiment of the above, the through-hole is square-shaped. In other embodiments, the through-hole can be any suitable alternative regular (e.g. circular) or irregular shape. In further embodiments, there may also be a plurality of through-holes, either of the same or different shapes.

In a further embodiment of any of the above, the heating portion defines a longitudinal axis along which the heating portion extends, and the anchoring feature extends transverse to the longitudinal axis. In some embodiments, the anchoring feature is a protrusion extending from the anchoring portion.

In a further embodiment of any of the above, the heating element upstands in the heating chamber.

In a further embodiment of any of the above, the heating element is substantially blade-shaped. In an alternative further embodiment of any of the above, the heating element is substantially pin-shaped.

In a further embodiment of any of the above, the device further comprises a wall projecting from the mount to define the heating chamber that encircles the heating portion of the heating element.

In a further embodiment of any of the above, the heating element instead comprises a peripheral wall defining at least part of the heating chamber.

In a further embodiment of any of the above, the heating element comprises a susceptor which is heatable by penetration with a varying magnetic field.

In a further embodiment of the above, the device further comprise an inductor coil extending around the susceptor, wherein the inductor coil is configured to generate the varying magnetic field.

In a further embodiment of any of the above, the device further comprises a heater assembly receiving chamber, wherein the heater assembly is removeably secured to the device in the heater assembly receiving chamber.

In a further embodiment of any of the above, the anchoring portion of the heating element comprises a larger axial cross-sectional area than a base of the heating portion of the heating element. In an alternative further embodiment of any of the above, the anchoring portion of the heating element may comprise an axial cross-sectional area substantially equal to that of a base of the heating portion of the heating element.

In a further embodiment of any of the above, the mount may comprise a mouldable material. The mouldable material may be a polymer material, for example, polyether ether ketone (PEEK).

According to another aspect of the present disclosure, there is provided an aerosol provision device heater assembly that comprises a heating element configured to heat at least a portion of an article comprising aerosol generating material, and a mount supporting the heating element. The heating element includes a heating portion and an anchoring portion, and the anchoring portion is insert moulded into the mount such that the anchoring portion is embedded within the mount.

Any of the heater assembly features of the embodiments discussed in relation to the aerosol provision device above also apply equally to this aspect.

According to another aspect of the present disclosure, there is provided an aerosol provision system. The system comprises an aerosol provision device according to the above aspect or any of its discussed embodiments, and an article comprising aerosol generating material. The article is dimensioned to be at least partially received within the heater assembly.

According to another aspect of the present disclosure, there is provided a method of forming a heater assembly by insert moulding an anchoring portion of a heater element into a mount.

According to another aspect of the present disclosure, there is provided a method of forming a heater assembly. The method comprises: placing a heating element having an anchoring portion into a mould, wherein the mould includes a cavity that envelopes the anchoring portion; injecting molten material into the mould, the mould guiding molten material to the cavity; and allowing the molten material to solidify in the cavity around the anchoring portion.

In either of the above method aspects, the heater assembly formed may have the any of the features of the embodiments discussed in relation to the aerosol provision device above.

Reference to ‘axial’ in the above discussion refers to a direction along the longitudinal axis of the heater assembly. Similarly, an ‘axial cross-section’ relates to the cross-section in taken in a plane taken across the longitudinal axis and perpendicular thereto.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a side view of an example of an aerosol provision device;

FIG. 2 shows a partially exploded side view of the aerosol provision device of FIG. 1 showing a chassis, end members, power source, aerosol generating assembly, replaceable article, and outer cover;

FIG. 3 shows a cross-sectional view of part of the aerosol provision device of FIG. 1;

FIG. 4 shows a cross-sectional view of part of an alternative example of the part of aerosol provision device of FIG. 3;

FIG. 5 is a perspective, transparent view of the heater assembly from the part of the aerosol provision device of FIG. 3; and

FIG. 6 is a perspective, transparent view of the heater assembly from the part of the aerosol provision device of FIG. 4.

FIG. 7 is a flow chart outlining the insert moulding method for embedding the anchoring portion into the mount when forming the heater assembly from the part of the aerosol provision device of FIG. 4.

### DETAILED DESCRIPTION

As used herein, the term “aerosol generating material” includes materials that provide volatilised components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporise an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

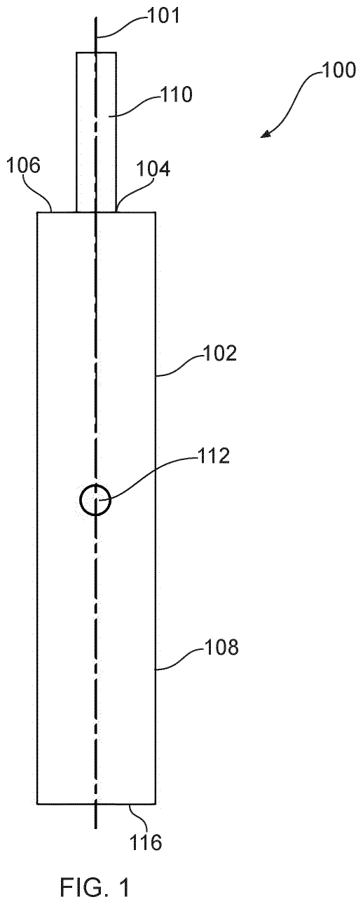

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

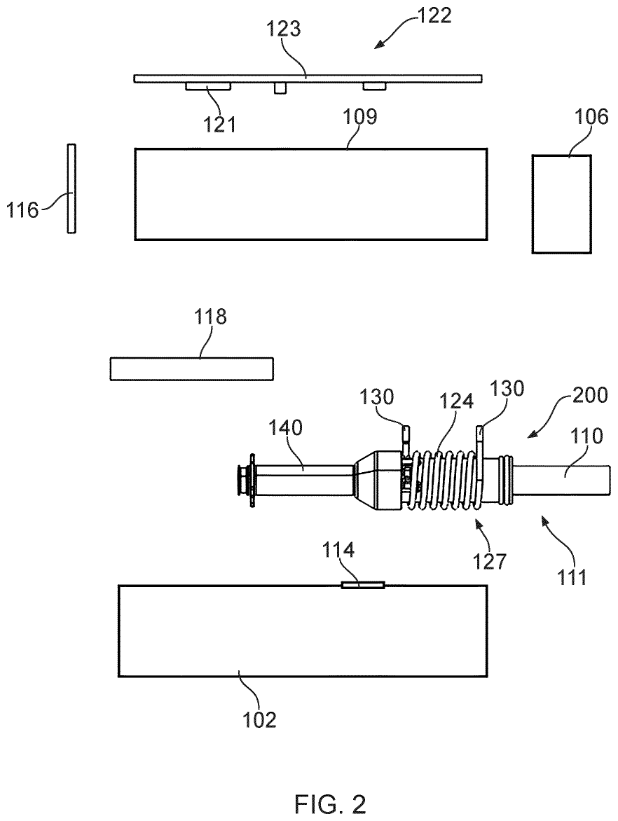

The device 100 comprises a housing 102 (including an outer cover 108) which surrounds and houses various components of the device 100. The device 100 has an opening 104 in one end, through which the article 110 may be inserted for heating by a heater assembly 200 (refer to FIG. 2). In use, the article 110 may be fully or partially inserted into the heater assembly 200 where it may be heated by one or more components of the heater assembly 200.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic exploded view of the device 100 of FIG. 1. The device 100 comprises the outer cover 108, a first end member 106 and a second end member 116. The device 100 includes a chassis 109, a power source 118, and an aerosol generating assembly 111 including the heater assembly 200. The device 100 further comprises at least one electronics module 122.

The outer cover 108 forms part of a device shell. The first end member 106 is arranged at one end of the device 100 and the second end members 116 is arranged at an opposite end of the device 100. The first and second end members 106, 116 close the outer cover 108. The first and second end members 106, 116 form part of the shell. The device 100 in embodiments comprises a lid (not shown) which is moveable relative to the first end member 106 to close the opening 104 when no article 110 is in place.

The device 100 may also comprise an electrical component, such as a connector/port 114, which can receive a cable to charge a battery of the device 100. For example, the connector may be a charging port, such as a USB charging port. In some examples the connector may be used additionally or alternatively to transfer data between the device 100 and another device, such as a computing device.

The device 100 includes the chassis 109. The chassis 109 is received by the outer cover 108. The aerosol generating assembly 111 comprises the heater assembly 200 into which, in use, the article 110 may be fully or partially inserted where it may be heated by one or more components of the heater assembly 200. The aerosol generating assembly 111 and the power source 118 are mounted on the chassis 109. The chassis 109 is a one piece component.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 108 may also define a portion of the end surfaces. The first and second end members 116 close open ends of the outer cover 108. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generating assembly 111 to supply electrical power when required and under control of a controller 121 to heat the aerosol generating material.

The power source 118 and aerosol generating assembly 111 are disposed in an axial arrangement, with the power source 118 at the distal end of the device 100 and the aerosol generating assembly 111 at the proximal end of the device 100. Other configurations are anticipated.

The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals may be electrically connected to the PCB 123 so that power can be distributed throughout the device 100. The connector 114 may also be electrically coupled to the battery 118 via the electrical tracks.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

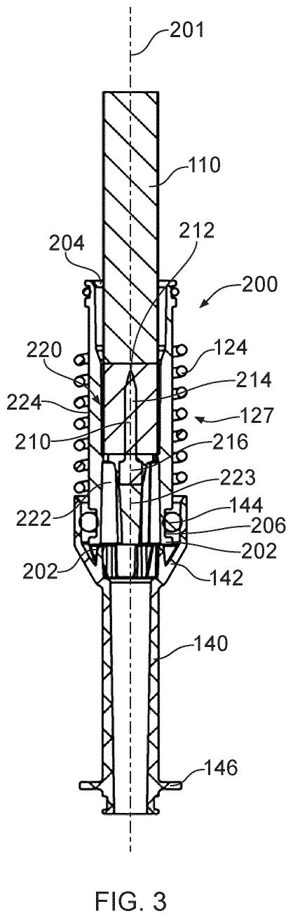

FIG. 3 shows a cross-sectional view of part of the device 100, that includes the heater assembly 200 and an inductor coil assembly 127.

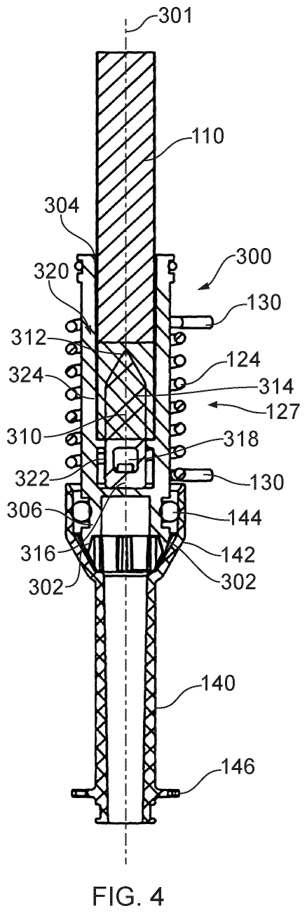

FIG. 4 shows a cross-sectional view of an alternative embodiment of a heater assembly 300 and the inductor coil assembly 127.

Common elements between the heater assembly 200 shown in FIG. 3 and the heater assembly 300 shown in FIG. 4 retain the same reference numerals but specified in the format 2xx and 3xx, respectively. The description of these common elements applies equally to either heater assembly 200, 300.

The aerosol generating assembly 111 comprises the inductor coil assembly 127 and the heater assembly 200, 300. The inductor coil assembly 127 extends around the heater assembly 200, 300. The inductor coil assembly 127 includes an inductor coil 124 wrapped around (i.e. surrounding) the heater assembly 200, 300. The inlet tube 140 is provided at the distal end of the heater assembly 200, 300. The inlet tube 140 includes a funnel portion 142 that receives attachment hooks 202 of the heater assembly 200, 300 for holding the heater assembly 200, 300 in place therein. The attachment hooks 202 may be fixedly held in the funnel portion 142 by an interference fit. An O-ring seal 144 is placed in a recess 206 on the heater assembly 200, 300 and is used to provide a seal between the funnel portion 142 and the heater assembly 200, 300. The inlet tube 140 may be used to allow airflow to be drawn from the distal end of the device 100 to the heater assembly 200, 300 and/or allow access to the distal end of the heater assembly 200,300 for cleaning purposes. The inlet tube 140 comprises a flange 146 at its distal end to allow it to be secured into the device housing 102.

The heater assembly 200, 300 includes a heating element. In the exemplified embodiment of FIG. 3, this heating element is a susceptor arrangement 210 (herein referred to as “a susceptor”). The susceptor 210 of this example is a pin-shaped member with a circular cross-section along its axial length around which an aerosol generating material can be placed. For example, the article 110 can be inserted onto or around the susceptor 210. The susceptor 210 has a generally constant diameter along the majority of its axial length, and then tapers to a pin tip 212. In other examples, the diameter of the susceptor 210 may vary continuously along the axial length of the susceptor 210 to the pin tip 212.

In another example, as shown in FIG. 4, the susceptor may be a blade-shaped susceptor 310. The blade-shaped susceptor 310 may have a constant rectangular cross-section along the majority of its axial length and then taper to a blade tip 312. In a similar manner to the pin-shaped susceptor 210, the article 110 can be insert onto or around the susceptor 310.

Although the pin-shaped and blade-shaped embodiments of the susceptor 210, 310 are depicted, it should be understood that within the scope of this disclosure the susceptor can take any number of suitable shapes and configurations. For example, the susceptor may take the form of a rod (e.g. a cylindrical rod or a square rod) with a constant or varying cross-section along its axial length that omits a tip or tapered portion.

In further examples, the susceptor 210 may be a tubular member within which the article 110/aerosol generating material is received. Such a susceptor is an outer susceptor. In such an example, the susceptor may define a peripheral wall (e.g. an annular wall) that defines at least part of a heating chamber within which the article 110 can be received and heated. In such an example, the susceptor surrounds the article 110, instead of the articles 110 surrounding the susceptor as in the pin-shaped and blade-shaped embodiments discussed above. It will be understood that the cross-sectional profile of the outer susceptor may be formed in a variety of profile shapes.

In further examples, multiple susceptors (e.g. two or more separate susceptors) may also be provided, and may be of differing or similar configurations (e.g. pin-shaped, blade-shaped, rod-shape or tubular-type etc.), as required.

The susceptor 210, 310 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The heater assembly 200 may therefore comprise electrical contacts for electrical connection with the apparatus for electrically activating the heating element by passing a flow of electrical energy through the heating element. In such embodiments, inductive coil assembly 127 can be omitted as appropriate.

The inductor coil 124 is made from an electrically conducting material. In this example, the inductor coil 124 is made from Litz wire/cable which is wound in a helical fashion to provide a helical inductor coil 124. Litz wire comprises a plurality of individual wires which are individually insulated and are twisted together to form a single wire. Litz wires are designed to reduce the skin effect losses in a conductor. In the example device 100, the inductor coil 124 is made from copper Litz wire which has a circular cross section. In other examples the Litz wire can have other shape cross sections, such as rectangular. Ends 130 of the inductor coil 124 can be connected to the PCB 123 (refer to FIG. 2) to control the activation of inductive heating therefrom using the electronics module 122 and switch 112.

The number of inductor coils used may also differ. For example, although the heater assemblies 200, 300 shown in FIGS. 3 and 4 includes an inductor coil assembly 127 with only a single coil 124, it should be understood that the inductor coil assembly 127 can feature any number of suitable coils. Additional coils may be used to provide different heating zones with different heating characteristics for the susceptors 210, 310 (e.g. provide different heating conditions to different areas along the axial length of the susceptors 210, 310 and/or provide different heating conditions to the susceptors 210, 310 at different times or for different use cases). Additional coils may also be provided to generate heating in additional susceptors that may be disposed in the heater assembly 200 (not shown).

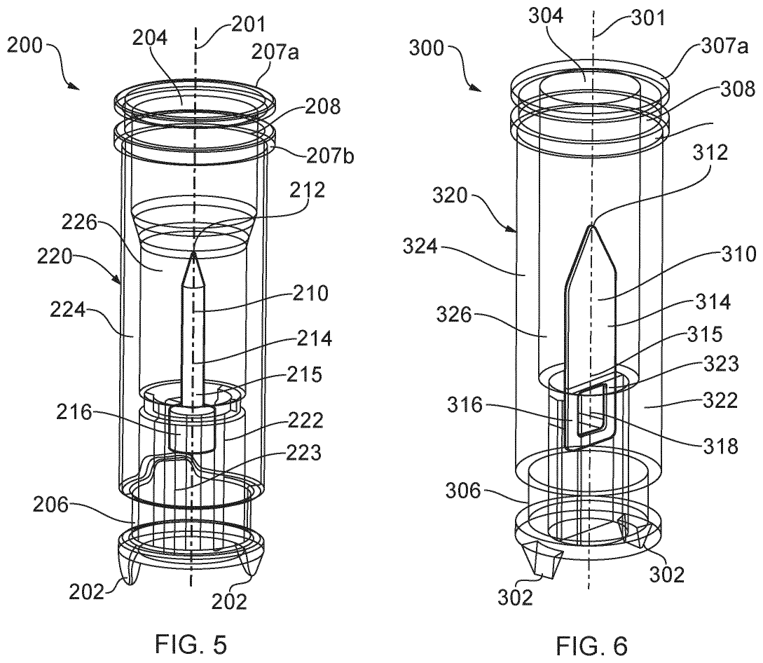

FIG. 5 shows a perspective view of the heater assembly 200 in isolation from the rest of the device 100. The heater assembly 200 is defined by a body 220. The body 220 in FIG. 5 is shown as transparent to reveal the structure within the heater assembly 200 to facilitate explanation of its features. However, in practice, the body may not be transparent and will hide these features from view.

In the depicted example, the body 220 is a generally annular element that defines a longitudinal axis 201, which, when used in the device 100 is generally aligned parallel to the longitudinal axis 101. In some examples, it may be co-axial with the longitudinal axis 101 or in others it may be offset therefrom. The body 220 includes the previously mentioned attachment hooks 202 extending distally therefrom and the O-ring recess 206 defined around its circumference at the distal end thereof. The body 220 also includes a proximal opening 204 that is suitable for receiving the replaceable article 110 comprising aerosol generating material. The opening 204 is defined by two annular flanges 207a, 207b separated by an annular recess 208. The flanges 207a, 207b and recess 208 may be used to aid secure fitment of the body 220 into the device 100.

The body 220 may be defined as a fixed part in the device 100/chassis 209, or may be removeably attached to the device 100/chassis 209. In the case of the latter, the device 100/chassis 209 may define a heater assembly chamber (not shown) that receives the body 220. The body 220 is removeably secured in the chamber, e.g. by using attachment hooks 202 to form a removeable engagement with the inlet tube 140 (e.g. a removable rotational engagement, threaded engagement or interference fit). In this manner, the heater assembly 200 as a whole can be removed from the device 100 itself, which may facilitate cleaning of the heater assembly 200 after use, and easy replacement in case of failure of the heater assembly 200 (e.g. such as breakage of the heating element 210).

In the depicted example, the body 220 comprises a mount 222 and a wall 224 protruding axially along axis 201 from the mount 222. The body 220 defines a receptacle within which the article 110 is received. The aerosol generating material is received in the receptacle. The receptacle defines a heating chamber 226. The heating chamber 226 is arranged to receive at least a portion of the article 110 comprising aerosol generating material in use. The mount 222 defines a base of the heating chamber 226. The wall 224 is generally annular and encircles the heating element 210. In this manner, the wall 224 defines an annular space around the heating element 210 that provides space around the heating element 210 for heating the aerosol generating material in use.

The heating element 210 includes an anchoring portion 216 that is embedded within the mount 222. It may also be said that the anchoring portion 216 is enveloped by the mount 222. The mount 222 supports the heating element 210 by securing the anchoring portion 216 in place within it. The anchoring portion 216 is used to provide an anchor point to hold the heating element 210 securely in place within the mount 222. The mount 222 also defines air passages 223 there through that may be used to communicate airflow from the inlet tube 140 to the heating chamber 226. In other examples, however, the air passages 223 may not be present in the mount 222, and may exist in other parts of the body 220. Air passages 223 may also have any suitable shape or air path configuration to allow airflow to communicate from the exterior of the device 100 to the heating chamber 226 when the user draws on the device 100.

The heating element 210 also includes a heating portion 214 that extends from the anchoring portion 216 and protrudes out from the mount 222 along longitudinal axis 201. In this manner, the extension of the heating element 210 can be said to be defined along the longitudinal axis 201, and is upstanding in the heating chamber 226. The heating portion 214 is the portion of the heating element 210 around which aerosol generating material is held during use in the heating chamber 226. The heating portion 214 and anchoring portion 216 are formed integrally together, such that the heating element 210 is a single, integral structure. In other words, the heating element 210 is a one piece component.

In order for the anchoring portion 216 to be embedded within and enveloped by the mount 222, it is insert moulded with the mount 222 during manufacture of the heating assembly 200.

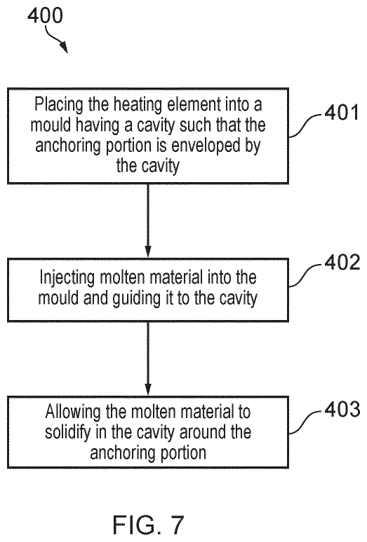

As shown in FIG. 7, in such an insert moulding process 400 the anchoring portion 216 is inserted into a mould cavity before forming the mount 222 (step 401). The mount 222 is then formed by injecting molten mount material into the cavity (step 402). Subsequent solidification (step 403) of the molten mount material in the cavity results in the anchoring portion 216 being embedded therein and enveloped thereby. In this manner, the anchoring portion 216 can be said to be moulded integrally within the mount 222. It should be understood that the rest of the body 220, including the wall 224, can also be moulded as part of the same process by shaping the mould used appropriately.

Such an insert moulded heater assembly 200 may allow for improvements in the bond strength between the anchoring portion 216 and the mount 222, and consequently may provide improvements in the strength and durability of the mounting and positioning of the heating element 210 within the heating chamber 226. This can be important in the exemplified device 100, due to the need for replaceable articles 110 to be repeatably inserted and removed around the heating element 210 during use.

The insert moulded heater assembly 200 may also provide improvements in relation to providing improved fluid and contaminant isolation between the heating chamber 226 and the heating electronics of the device 100. For example, by having the heating element 210 integrally formed into the mount 222 via the anchoring portion 216 being embedded therein this may prevent unwanted ingress of aerosol generating materials or other contaminants deposited during use of the device 100 (e.g. water vapour etc.) towards the heating electronics in the device 100 e.g. from around the heating element 210.

The mount 222 (and body 220) is made of any suitable mouldable material for such an insert moulding process. In one example, the mouldable materials is a non-metallic material, such as a polymer material.

Non-metallic/polymer materials may assist with limiting interference with magnetic induction for susceptor heating. They may also act as insulating material to help insulate other components of the device 100 from the heat generated by the heating element 210.

It will be understood that such non-metallic/polymer materials should have a melting point above the intended maximum temperature of the heating element 210 during use. In some examples, in use, the inductor coil 124 is configured to heat the susceptor 210 to a temperature of between about 200° C. and about 350° C., such as between about 240° C. and about 300° C., or between about 250° C. and about 280° C.

One particularly suitable polymer material is polyether ether ketone (PEEK), which is a good insulator, has a sufficiently high melting point of about 343° C., and can used in insert moulding processes. Nonetheless, other suitable materials will be readily apparent to the skilled person, and any of these are envisaged within the scope of this disclosure.

In the depicted example, the anchoring portion 216 has a larger axial cross-sectional area than a base 215 of heating portion 214 that connects to the anchoring portion 216. This may help to provide a stronger base for the heating portion 214 to extend from. The depicted example has a circular cross-section of larger diameter than that of the heating portion 214. In other examples, any other suitable cross-section of anchoring portion 216 can be used (e.g. square, hexagonal, rectangular etc.) and may match or differ from that of the heating portion base 215. In other or additional examples, the anchoring portion 216 could nonetheless be a smaller or have the same axial cross-sectional area as the base 215 of the heating portion 214.

FIG. 6 shows a perspective view of the heater assembly 300 in isolation from the rest of the device 100. Again, the body 320 in FIG. 6 is shown as transparent to reveal the structure within the heater assembly 300 to facilitate explanation of its features. However, in practice, the body may not be transparent and will hide these features from view. Also, again the common elements of heater assembly 300 compared to heater assembly 200 retain the same reference numerals but specified in the format 3xx instead of 2xx. The description of these common elements in relation to FIG. 5 applies equally to those of FIG. 6, and so will not be repeated below.

The features relating to the fixed or removeable fixation of the heater assembly 200 in the device 100 also apply equally to the heater assembly 300/body 320 of FIG. 6.

In FIG. 6, the anchoring portion 316 has the same axial cross-sectional area and shape (i.e. rectangular) as the heating portion 314.

The anchoring portion 316 also further includes an anchoring feature that increases the area of contact between the mount 222 and the anchoring portion 316 to help improve the strength of the bond there between.

In the depicted example the anchoring feature is a through-hole 318 that passes through the anchoring portion 316. The through-hole 318 passes through the anchoring portion 316 transversely to the longitudinal axis 301. During the insert moulding process, the mount material will flow through the through-hole 318 and solidify therein. This may provide further improvements in the strength and durability of the connection between the anchoring portion 316 and the mount 222. In this example, the through-hole 318 is square-shaped; however, the through-hole 318 can be any other suitable regular or irregular shape. In other examples, there may also be a plurality of through-holes 318, either of the same or different shapes. The through-hole 318 size can also be varied or chosen as required to meet specific design requirements.

Although the anchoring feature in the depicted example is a through-hole 318, it is to be understood that this disclosure extends to cover any other suitable anchoring feature(s) that are effective at increasing the area of contact between the mount 22 and the anchoring portion 316.

For example, the anchoring feature may instead be a recess that extends only partially into the anchoring portion 316. The recess receives an additional portion of mount material therein. Such a recess could take any suitable form, such as a discrete circular or square recess, or a groove or channel that extends around the anchoring portion 316. There may also be a plurality of recesses or pattern thereof provided.

In yet further examples, the anchoring feature may be one or more protrusions that extend from the anchoring portion 316 and into the mount 222. The protrusions may extend from the anchoring portion 316 at any suitable angle from the longitudinal axis 310 (e.g. transverse to the longitudinal axis 301), and make take any suitable shape, such as cylindrical or square rods.

In yet another example, the anchoring feature may be a surface roughening of the anchoring portion 316. Such a surface roughening will provide more surface area of contact between the mount 222 and the anchoring portion 316. Such a surface roughening can take any suitable form, such as a series of scratches/depressions formed by sanding or other surface treatment on the anchoring portion 316 before it is moulded into the mount 222.

In further examples, the anchoring portion 316 may feature a combination of different types of anchoring features.

Although the through-hole 318 and other example anchoring features discussed above are shown in relation to the blade-shaped heating element 310, it can be equally applied to the anchoring portion of any other suitable shape of heating element, such as the anchoring portion 216 of the pin-shaped heating element 210.

In the case of a tubular-type susceptor (such as discussed above), a base portion of the peripheral wall will define the anchoring portion that is moulded into the mount 222 and this base portion can define the anchoring feature(s) therein as required.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising:
a heater assembly having:
a receptacle defining a heating chamber arranged to receive at least a portion of an article comprising aerosol generating material;
a heating element configured to heat a portion of the article received in the heating chamber; and
a mount supporting the heating element;
wherein the heating element includes a heating portion and an anchoring portion, and the anchoring portion is insert molded into the mount such that the anchoring portion is embedded within the mount.

2. The aerosol provision device of claim 1, wherein the heating portion extends from the anchoring portion and extends from the mount.

3. The aerosol provision device of claim 1, wherein the anchoring portion comprises an anchoring feature.

4. The aerosol provision device of claim 3, wherein the anchoring feature comprises a recess in the anchoring portion and a portion of the mount is received by the recess to couple the anchoring portion to the mount.

5. The aerosol provision device of claim 4, wherein the recess comprises a through-hole in the anchoring portion, and a portion of the mount extends through the through-hole to couple the anchoring portion to the mount.

6. (canceled)

7. The aerosol provision device of claim 3, wherein the heating portion defines a longitudinal axis along which the heating portion extends, and the anchoring feature extends transverse to the longitudinal axis.

8. The aerosol provision device of claim 1, wherein the heating element upstands in the heating chamber.

9. The aerosol provision device of claim 1, wherein the heating element is substantially blade-shaped.

10. The aerosol provision device of claim 1, further comprising a wall projecting from the mount to define the heating chamber that encircles the heating portion of the heating element.

11. The aerosol provision device of claim 1, wherein the heating element comprises a peripheral wall defining at least part of the heating chamber.

12. The aerosol provision device of claim 1, wherein the heating element comprises a susceptor which is heatable by penetration with a varying magnetic field.

13. The aerosol provision device of claim 12, further comprising an inductor coil extending around the susceptor, wherein the inductor coil is configured to generate the varying magnetic field.

14. The aerosol provision device of claim 1, further comprising a heater assembly receiving chamber, wherein the heater assembly is removably secured to the aerosol provision device in the heater assembly receiving chamber.

15. The aerosol provision device of claim 1, wherein the anchoring portion of the heating element comprises a larger axial cross-sectional area than a base of the heating portion of the heating element.

16. The aerosol provision device of claim 1, wherein the anchoring portion of the heating element comprises an axial cross-sectional area substantially equal to that of a base of the heating portion of the heating element.

17. The aerosol provision device of claim 1, wherein the mount comprises a moldable material.

18. The aerosol provision device of claim 17, wherein the moldable material is a polymer material.

19. (canceled)

20. An aerosol provision device heater assembly comprising:
a heating element configured to heat at least a portion of an article comprising aerosol generating material; and
a mount supporting the heating element;
wherein the heating element includes a heating portion and an anchoring portion, and the anchoring portion is insert molded into the mount such that the anchoring portion is embedded within the mount.

21. A method of forming an aerosol provision device heater assembly comprising:
insert molding an anchoring portion of a heater element into a mount.

22. A method of forming an aerosol provision device heater assembly comprising:
placing a heating element having an anchoring portion into a mold, wherein the mold includes a cavity that envelopes the anchoring portion;
injecting molten material into the mold, the mold guiding the molten material to the cavity; and
allowing the molten material to solidify in the cavity around the anchoring portion.

23. An aerosol provision system comprising:
the aerosol provision device according to claim 1; and
an article comprising aerosol generating material, wherein the article is dimensioned to be at least partially received within the heater assembly.
